(19) United States
(12) Patent Application Publication
(10) Pub. No.: US 2017/0185157 A1
(43) Pub. Date: Jun. 29, 2017

(54) OBJECT RECOGNITION DEVICE

(71) Applicant: Robert Bosch GmbH, Stuttgart (DE)

(72) Inventors: Christoph Delfs, Bretten (DE); Niklas Dittrich, Pliezhausen (DE); Felix Schmidt, Stuttgart (DE); Frank Fischer, Gomaringen (DE)

(73) Assignee: Robert Bosch GmbH, Stuttgart (DE)

(21) Appl. No.: 15/304,967

(22) PCT Filed: Mar. 3, 2015
(86) PCT No.: PCT/EP2015/054389

§ 371 Date: Oct. 18, 2016

(30) Foreign Application Priority Data
Apr. 28, 2014 (DE) 10 2014 207 932.2

(51) Int. Cl. G06F 3/01; G01B 11/14; G06K 9/00; G01S 17/02; G01S 3/786; G01B 11/00; G06F 3/0488

(52) U.S. Cl. CPC G06F 3/017; G01B 11/002; G01B 11/14; G06F 3/04883; G01S 17/02; G06F 3/011; G01S 3/786; G06K 9/00355; G06K 9/00335; G06T 2207/30196

(57) ABSTRACT

A method for contactlessly interacting with a module, the module having a first submodule and a second submodule; in a first method step, the first submodule producing a primary beam; in a second method step, the second submodule inducing a scanning movement of the primary beam to allow image information to be projected into a projection area; in a third method step, a control command executed by an object being recognized by the module; the control command relating to contactlessly interacting with the module; in the third method step, the module detecting a geometric shape of the object.

### BACKGROUND INFORMATION

The present invention relates to a method for contactlessly interacting with a module. The present invention also relates to a laser projector and to a module having an interface for contactlessly interacting with an object.

Devices for providing a human-machine interface are generally available.

### SUMMARY

It is an object of the present invention to provide a method, a module and a laser projector, whereby control commands are recognized by capturing user gestures with a relatively high precision.

The method according to the present invention for contactlessly interacting with the module, and the module and the laser projector in accordance with the present invention may have the advantage over the related art that a module detects an object—for example, a finger or a hand of a user, used for contactlessly interacting with the module, with a relatively high precision, so that control commands or input commands are recognized, in particular by sensing user gestures. In addition, a geometric shape is associated with a specific control command in response to detection of a geometric shape of the object, the geometric shape relating, for example, to specific hand signals and/or finger movements. A contactless interaction of the object with the module preferably includes controlling the module, respectively an electrical device when the module is integrated in the electrical device or is attached thereto. The first submodule is preferably a red-green-blue (RGB) module, in particular a semiconductor laser component, the first submodule being configured for generating a laser beam (primary beam). The scanning movement preferably refers to a movement of the primary beam where an image is assembled that is visible to the user, for example, an individual image of a video sequence or a fixed image, by projecting the image information line-by-line into the projection area. A control command is preferably an input command for controlling the module and/or the laser projector. The control command is detected, in particular by finding the position of the object using the primary beam and detecting a secondary signal generated by reflection off of the object.

Advantageous embodiments and refinements of the present invention are described herein with reference to the figures.

One preferred further embodiment provides that the geometric shape of the object be recognized by object outline detection.

This advantageously allows a relatively rapid object recognition, the object being recognized, for example, by using the same primary beam used for projecting the image information. The object outline detection includes, in particular determining a contour, respectively boundary of the object (respectively, of a subregion of the object) in relation to an outline of the object (respectively of a subregion of the object) along a plane around the object that is substantially orthogonal to a propagation direction of the primary beam.

Another preferred embodiment provides that the module recognize the control command as a function of the detected geometric shape of the object and/or as a function of a detected further geometric shape of the object.

This advantageously makes it possible to detect a change in the geometric shape of the object. In particular, user gestures may also be hereby recognized. In addition, a control command that is associated with the user gesture is detected in particular; those user gestures being sensed, in particular where the geometric shape of the object is changed, the hand or finger moving from a curved position to an extended position, for example.

One preferred further embodiment provides that the second submodule include a scanning mirror structure; a deflection movement acting upon the scanning mirror structure in a way that allows the primary beam to sweep over the object line-by-line during the scanning movement.

A module having a comparatively compact and cost-effective design is hereby advantageously provided that may be adaptively integrated into an electrical device—in particular, a portable laser projector, in accordance with the modular design principle. The scanning mirror structure is preferably a microelectromechanical scanning mirror structure.

Another preferred further embodiment provides that the module include a third submodule; in the third method step, the third submodule detecting a secondary signal generated by the reflection of the primary beam off of the object; the module generating a position-finding signal as a function of the detected secondary signal in a way that allows the position-finding signal to contain information about the geometric shape of the object.

This advantageously allows the information on the object's geometric shape to be derived from the position-finding signal.

For example, the position-finding signal contains distance information pertaining to a distance of a projection point generated by the primary beam on the surface of the object, to the module, the distance information being assignable to a deflection position of the scanning mirror structure.

Another preferred embodiment provides that the third submodule be spaced apart from the second submodule; the position-finding signal being configured as a function of the detected secondary signal in a way that allows the position-finding signal to contain shadowing information regarding a subregion of the object; in particular, the subregion being shadowed relative to another subregion.

The object outline detection may hereby be advantageously realized by detection of a shadowed region, the shadowed region relating, in particular to a subregion of the object that is not or is only partially captured by the primary beam during the scanning movement.

Another preferred embodiment provides that the module include two spatially separate detectors; the second detector stereoscopically detecting the secondary signal in the third method step. Another preferred embodiment provides that a first detector of the two detectors detects a first partial secondary signal of the secondary signal in the third method step, and that a second detector of the two detectors detects a second partial secondary signal of the secondary signal. Another preferred embodiment provides that the module generate a first partial position-finding signal as a function of the detected first partial secondary signal and a second partial position-finding signal as a function of the detected second partial secondary signal; the position-finding signal being generated by superimposing the first and second partial position-finding signals; in particular, the geometric shape of the object being recognized by evaluating the position-finding signal.

This advantageously makes it possible for control commands to be recognized by capturing user gestures with a relatively high precision. In particular, an object may be hereby recognized relatively rapidly and reliably by object outline detection, at least two detectors—in particular optical sensors, which are configured, for example, on both sides relative to the second submodule (respectively, the scanning mirror structure)—each preferably recording one image of the object. The at least two images of the object recorded by the at least two detectors are superimposed in this way; in particular, a contour, respectively an outline of the object and/or a shadowed region being detected.

One preferred embodiment of the module according to the present invention provides that the second submodule feature a scanning mirror structure for deflecting the primary beam in a deflection position of the scanning mirror structure; the scanning mirror structure being configured for changing the deflection position in a way that allows the primary beam to execute a line scanning movement.

A module having a comparatively compact and cost-effective design is hereby advantageously provided that may be adaptively integrated into an electrical device—in particular, a portable laser projector, in accordance with the modular design principle. The scanning mirror structure is preferably a microelectromechanical scanning mirror structure.

One preferred embodiment of the module according to the present invention provides that the module have a first detector for detecting a first partial signal of a secondary signal generated by the reflection of the primary beam off of the object; and/or the module having a second detector for detecting a second partial signal of the secondary signal;
the first and/or the second detectors being spaced at a distance from the second submodule; and/or
the first and the second detectors being mutually spaced apart in a way that allows the object to be stereoscopically detected by the two detectors.

This makes it advantageously possible to improve object recognition by detecting a shadowed subregion; in particular, an outline, respectively a contour of an object, respectively of a subregion of the object (for example, of the shadowed region) being detected.

In particular, the first and/or second detectors are/is integrated in the third submodule of the module.

Exemplary embodiments of the present invention are illustrated in the figures and explained in detail herein.

### BRIEF DESCRIPTION OF THE DRAWINGS

FIG. 1 shows a module in accordance with a specific embodiment of the present invention.

FIG. 2 shows a laser projector in accordance with a specific embodiment of the present invention.

FIGS. 3 and 4 show a module in accordance with various specific embodiments of the present invention.

### DETAILED DESCRIPTION OF EXAMPLE EMBODIMENTS

In the various figures, the same parts are always denoted by the same reference numerals and, therefore, are also typically only named or mentioned once.

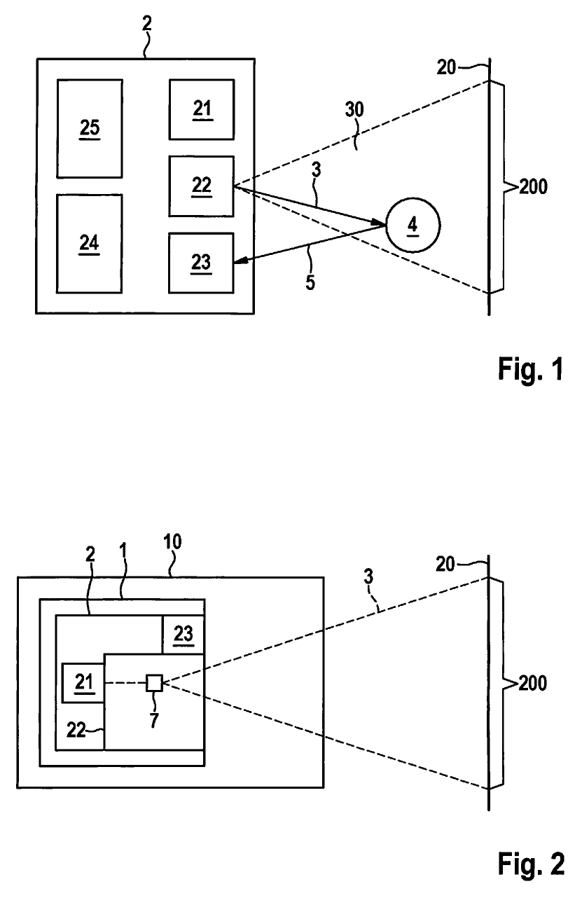

FIG. 1 shows a module 2 in accordance with a specific embodiment of the present invention. Module 2 provides an interface—in particular, a user interface, respectively a human-machine interface—HMI for contactlessly interacting with an object 4. Object 4 is a user-controlled selection object, respectively control object—for example, a finger, pen or other physical spatial object. In particular, module 2 interacts with object 4 by detecting a movement and/or position of object 4, the position of object 4, in particular, being found.

Module 2 has a first submodule 21 for generating a primary beam 3. First submodule 21 is, in particular a light module 21, preferably a laser module 21, especially a red-green-blue (RGB) module 21. Primary beam 3 is preferably a primary laser beam 3, primary laser beam 3 including red light, green light, blue light and/or infrared light.

In addition, module 2 has a second submodule 22 for deflecting primary beam 3, so that primary beam 3, in particular, executes a line scanning movement. Second submodule 22 is configured to allow image information to be projected into a projection area 200, in particular, at a projection surface 200 of a projection object 20, in response to deflection of primary beam 3. This means, in particular, that primary beam 3 executes the scanning movement in a way that makes it possible to project an image, which is visible to the user, at projection object 20—for example, a wall. The image information relates, in particular, to an image that is composed line-by-line—for example, a single image, respectively a still image of a video sequence, a photographic image, a computer-generated image and/or a different image. Second submodule 22 is preferably a scanning module 22, respectively a scanning mirror module 22, scanning mirror module 22 especially including a microelectromechanical system (MEMS) for deflecting primary beam 3.

Second submodule 22 acts upon primary beam 3 to produce a deflection movement that induces primary beam 3 to execute the scanning movement (i.e., in particular a multi-line, respectively raster-type scanning movement) along projection area 200 (i.e., in particular along projection surface 200 of projection object 20). Scanning mirror module 22 is preferably configured for generating a (time-dependent) deflection position signal indicative of a deflection position of scanning mirror module 22 during the scanning movement.

Module 2 preferably has a third submodule 23, in particular a detection module 23 for detecting a secondary signal 5 generated by primary beam 3 interacting with object 4. For example, the secondary signal is produced in response to primary beam 3 being reflected off of object 4 when object 4 is positioned and/or moved relative to module 2 in a way that induces primary beam 3 to capture object 4 during the scanning movement thereof. This means, for example, that object 4 is positioned in a position finding zone 30 associated with primary beam 3. In particular, detection module 23 generates a (time-dependent) detection signal, the detection signal, in particular, including information about detected secondary signal 5.

Module 2 preferably has a fourth submodule 24 for generating a position-finding signal, position-finding signal, in particular, including information regarding a (time) correlation of the detection signal with the deflection position signal. This advantageously allows detection of a position and/or a movement and/or a distance of object 4 (relative to module 2 and/or relative to projection object 20) without any contact—in particular, by using primary beam 3 to find the position of object 4. Here, “position finding” means, in particular, determining a position and/or a distance (using primary beam 3).

Module 2 preferably features a fifth submodule 25 for controlling first submodule 21 and/or second submodule 22. For example, fifth submodule 25 is a control module 25 for generating a control signal for controlling first submodule 21 and/or second submodule 22; the control signal, in particular, being generated as a function of the position-finding signal.

FIG. 2 shows a laser projector 1 in accordance with a specific embodiment of the present invention; a module 2 in accordance with a specific embodiment of the present invention being integrated in laser projector 1. The specific embodiment shown here is, in particular, substantially identical to the other specific embodiments according to the present invention. Here, laser projector 1 is configured on a support 10, for example, a table 10, module 2 being integrated in laser projector 1. Here, primary beam 3—i.e., in particular an RGB laser beam—is produced by RGB module 21 and directed at a scanning mirror structure 7 of scanning module 22, primary beam 3 being deflected by scanning mirror structure 7 in a way that allows it to execute a scanning movement. Primary beam 3 thereby executes the scanning movement thereof in a way that allows image information to be projected at a projection surface 200, at a projection object 20—for example, a wall or a different screen.

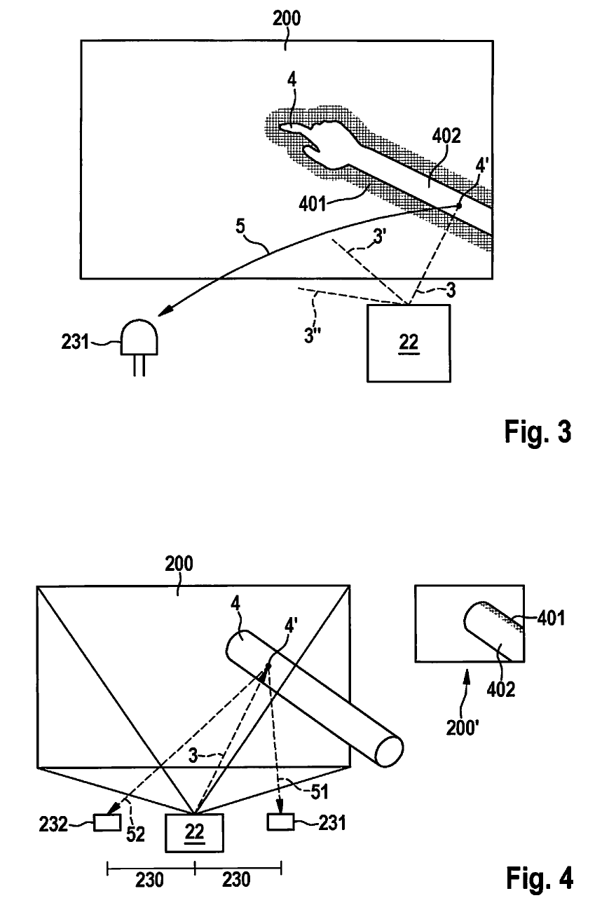

FIG. 3 shows a module 2 in accordance with a specific embodiment of the present invention; the specific embodiment shown here being substantially identical to the other specific embodiments of the present invention. This illustration shows a subregion 401 and another subregion 402 of object 4, subregion 401 being shadowed relative to further subregion 402. This means that subregion 401 is darker than other subregion 402 since, during the scanning movement, primary beam 3 only captures further subregion 402 and projection area 200 (and not subregion 401). Module 2 includes a detector 431 for detecting a secondary signal 5 generated by primary beam 3 reflecting off of object 4. For example, secondary signal 5 is generated by reflection of primary beam 3 in a projection area 4′, projection area 4′ being disposed in further subregion 402 of object 4. In addition, reference numerals 3′ and 3″ represent further propagation directions of primary beam 3 during the scanning movement, the intention being to illustrate that primary beam 3 strikes projection surface 200. Shadowed region 401 is detected by spacing detector 231 at a distance from second submodule 22 through which primary beam 3 is radiated. Due to the offset between detector 231 and second submodule 22, the reflected light of primary beam 3 (secondary signal 5) of some of the image points (of the projected image information) does not reach detector 231 in this instance.

FIG. 4 shows a module 2 in accordance with a specific embodiment of the present invention; the specific embodiment shown here being substantially identical to the other specific embodiments of the present invention. Module 2 includes two spatially separate detectors 231, 232. For example, relative to second submodule 22, the two detectors 231, 232 are disposed on both sides; each having an equal distance 230 to second submodule 22. Secondary signal 5, which is generated by reflection of primary beam 3 in a projection area 4′ (respectively, image point 4′) produced during the scanning movement on object 4, is preferably detected stereoscopically by the two detectors 231, 232. This means, in particular, that secondary signal 5 includes two partial secondary signals 51, 52, a first partial secondary signal 51 of secondary signal 5 detecting a first detector 231 of the two detectors 231, 232; and a second partial secondary signal 52 of secondary signal 5 detecting a second detector 232 of the two detectors 231, 232. The two detectors 231, 232—which, for example, are two optical sensors—each hereby record at least one image of object 4. The at least two images of object 4 recorded by the at least two detectors 231, 232 are preferably superimposed, in particular, a contour, respectively an outline of object 4 and/or of a shadowed region 401 being detected (see reference numeral 200′).

1-13. (canceled)

14. A method for contactlessly interacting with a module, the module including a first submodule and a second submodule, the method comprising:
in a first method step, producing, by the first submodule, a primary beam;
in a second method step, acting upon the primary beam, by the second submodule, to produce a scanning movement in a way that induces image information to be projected into a projection area;
in a third method step, recognizing, by the module, a control command executed by an object, the control command relating to the contactless interaction with the module, wherein the module detects a geometric shape of the object in the third method step.

15. The method as recited in claim 14, wherein the geometric shape of the object is recognized by object outline detection.

16. The method as recited in claim 14, wherein the module recognizes the control command at least one of: i) as a function of the detected geometric shape of the object, and ii) as a function of a detected further geometric shape of the object.

17. The method as recited in claim 14, wherein the second submodule has a scanning mirror structure, a deflection movement acting upon the scanning mirror structure in a way that allows the primary beam to sweep over the object line-by-line during the scanning movement.

18. The method as recited in claim 14, wherein the module has a third submodule, and wherein in the third method step, the third submodule detects a secondary signal generated by a reflection of the primary beam off of the object, the module generating a position-finding signal as a function of the detected secondary signal in a way that allows the position-finding signal to contain information regarding the geometric shape of the object.

19. The method as recited in claim 18, wherein the third submodule is spaced apart from the second submodule, the position-finding signal being configured as a function of the detected secondary signal in a way that allows the position-finding signal to contain shadowing information regarding a subregion of the object, the subregion being shadowed relative to another subregion.

20. The method as recited in claim 14, wherein the module includes two spatially separate detectors, the second detector stereoscopically detecting the secondary signal in the third method step.

21. The method as recited in claim 20, wherein a first detector of the two detectors detects a first partial secondary signal of the secondary signal in the third method step; and a second detector of the two detectors detects a second partial secondary signal of the secondary signal.

22. The method as recited in claim 21, wherein the module generates a first partial position-finding signal as a function of the detected first partial secondary signal, and a second partial position-finding signal is generated as a function of the detected second partial secondary signal; the position-finding signal being generated by superimposing the first and second partial position-finding signals; the geometric shape of the object being recognized by evaluating the position-finding signal.

23. A module, comprising:
an interface for contactlessly interacting with an object;
a first submodule for producing a primary beam; and
a second submodule for deflecting the primary beam, the second submodule being configured for generating a scanning movement of the primary beam in a way that allows the module to project image information into a projection area;
wherein the module is configured for recognizing a control command executed by an object, the control command relating to the contactless interaction of the object with the module, wherein the module is configured to allow the module to detect a geometric shape of the object.

24. The module as recited in claim 23, wherein the second submodule includes a scanning mirror structure for deflecting the primary beam in a deflection position of the scanning mirror structure, the scanning mirror structure being configured for changing the deflection position in a way that allows the primary beam to execute a line scanning movement.

25. The module as recited in claim 23, further comprising at least one of:
a first detector for detecting a first partial signal of a secondary signal generated by the reflection of the primary beam off of the object; and
a second detector for detecting a second partial signal of the secondary signal;
wherein the at least one of the first and the second detectors are spaced at a distance from the second submodule.

26. The module as recited in claim 23, further comprising:
a first detector for detecting a first partial signal of a secondary signal generated by the reflection of the primary beam off of the object; and
a second detector for detecting a second partial signal of the secondary signal;
wherein the first and the second detectors are mutually spaced apart in a way that allows the object to be stereoscopically detected by the two detectors.

27. A laser projector, comprising:
a module including an interface for contactlessly interacting with an object, a first submodule for producing a primary beam, and a second submodule for deflecting the primary beam, the second submodule being configured for generating a scanning movement of the primary beam in a way that allows the module to project image information into a projection area;
wherein the module is configured for recognizing a control command executed by an object, the control command relating to the contactless interaction of the object with the module, wherein the module is configured to allow the module to detect a geometric
